(19) United States
(12) Patent Application Publication
(10) Pub. No.: US 2004/0026497 A1
(43) Pub. Date: Feb. 12, 2004

(54) Apparatus and method for automatically exchanging money

(76) Inventors: Han-Sang Ho, Seoul (KR); Jeong-Su Oh, Seoul (KR)

Correspondence Address: SHERIDAN ROSS PC, 1560 BROADWAY, SUITE 1200, DENVER, CO, 80202

(21) Appl. No.: 10/296,300

(22) PCT Filed: May 16, 2001
(86) PCT No.: PCT/KR01/00789

(30) Foreign Application Priority Data
May 20, 2000 (KR) 2000-27250

(51) Int. Cl. G06F 17/60

(52) U.S. Cl. 235/379

(57) ABSTRACT

An apparatus for automatically exchanging money according to the present invention includes: a forged bill discriminator (60) for sorting kinds of bills of a first country and discriminating forgeries thereof; an exchange rate provider (40) for providing an exchange rate quotation; and an exchanger (70) for automatically exchanging the bills of the first country for bills of a second country based on the exchange rate from the exchange rate provider (40) in case where the bills of the first country are not forged ones.

### TECHNICAL FIELD

The present invention relates to an apparatus for exchanging money; and, more particularly, to an apparatus for automatically exchanging money and a money exchanging method, which is capable of discriminating forgeries of US dollars, sorting various bills of US dollars and exchanging them for Korean Wons according to an exchange rate.

### BACKGROUND ART

Generally, with development of electronic photo devices, such as a photocopying machine and a laser beam printer, an image resolution has been improved too, thereby providing more delicate image than a conventional photocopying machine. Consequently, misuse of the electronic photo devices is increasing with the generalization of electronic photo devices, and especially, forgeries of US dollars become a social problem.

To prevent the forgeries, Minting and Security Printing Corporation has made all its endeavors to discriminate the forged one. Also, a sheet made of specific material and noncopyable characters and symbols are used to check up the forgery in the US dollars.

Likewise, if forged US dollars are exchanged for Korean Wons, the reliability of money can be attacked with social problems. Also, customers carry out the exchanging only in a financial agency by themselves. That is why an automatic exchanger with an exchange rate is needed.

### DISCLOSURE OF INVENTION

It is, therefore, an object of the present invention to provide an apparatus or automatically exchanging money and a money exchanging method for discriminating US dollars and exchanging US dollars for Korean Wons by reliably distinguishing forgeries.

It is, therefore, another object of the present invention to provide an apparatus for automatically exchanging money and a money exchanging method for exchanging US dollars for Korean Wons with real time based on an exchanging rate.

It is, therefore, further another object of the present invention to provide an apparatus for automatically exchanging money and a money exchanging method for notifying an amount of exchangeable money by keypad inputs and showing an amount of exchangeable money in order to promptly exchange the US dollars for Korean Wons.

In accordance with an aspect of the present invention, there is provided an apparatus for automatically exchanging money, comprising: a forged bill discriminating means for sorting kinds of bills of a first country and discriminating forgeries thereof; an exchange rate providing means for providing an exchange rate quotation; and an exchange means for automatically exchanging the bills of the first country for bills of a second country based on the exchange rate from the exchange rate providing means in case where the bills of the first country are not forged ones. The exchange means comprises a plurality of containers for storing the bills of a second country by kinds of bills; and discharging means connected to each of containers for discharging the bills of the second country through one discharging line.

In accordance with another aspect of the present invention, there is provided an exchanging apparatus for automatically exchanging a bill of a first country for a bill of a second country, comprising: an exchange rate providing means for providing an exchange rate between the bills of the first and second countries; an exchange rate displaying means for notifying the exchange rate of the bill of the first country; a key input means or calculating an amount of exchangeable money of the first country for the second country according to the notified exchange rate; a forged bill discriminating means for discriminating the bill of the first country and sorting kinds of the bills or the first country;

a bill receipt/discharge means for receiving the bills of the second country and discharging the exchangeable bill of the second country according to the exchange rate of the bill of the first country when the inputted the bills of the first country are not forged ones; and a coin receipt/discharge means for exchanging a balance of the exchanged bill of the first country for coins of the second country and discharging the coins.

In accordance with further another aspect of the present invention, there is provided an exchanging apparatus for automatically exchanging bills of a first country for bills of a second country, comprising: a main body including a liquid crystal display unit, a bill insert unit, a bill discharge unit and a coin discharge unit; a control unit for controlling the whole operation, wherein the control unit is internally equipped to one-side of the main body; an exchange rate providing means for providing an exchange rate between bills of the first and second countries, wherein the exchange rate providing means is connected to one-side of the control unit; an exchange rate displaying means for displaying the received exchange rate; a key input means for optionally providing calculation of an amount of exchangeable bills of the second country according to the provided exchange rate; a forged bill discriminating means for discriminating bills inserted through the bill insert unit and discharging a forged bill; a bill receipt/discharge means for receiving the bills of the second country and discharging exchangeable bills of the second country into the bill discharge unit by a motor driving according to the provided exchange rate; and a coin receipt/discharge means for exchanging a balance of the bill of the first country for coins of the second country and discharging the coins.

In accordance still further another aspect of the present invention, there is provided an automatically exchanging method, wherein the method exchanges a bill of a first country for money of a second country using an automatic exchange system, comprising the steps of: a) providing and displaying an exchange rate; b) sorting kinds of the bills of the first country and discriminating forgeries of the bills; and c) if the bill is not a forged one, discharging the money of the second country according to the exchange rate.

In accordance with still further another aspect of the present invention, there is provided an automatically exchanging method, wherein the method exchanges bills of the first country for money of the second country using an automatic exchange system, comprising the steps of: a) determining if an initialization of the automatic exchange system is completed, and if completed, downloading an exchange rate of the bills of the first country through a modem communication; b) calculating the bills of the first country into the money of the second country according to the downloaded exchange rate and displaying the calculated amount; c) after the step a), receiving the bills of the first country, sorting kinds of the inserted bills of the first country and determining if the bill of the first country is a forged one or not; d) at the step c), if the bills of the first country are not forged ones, preparing the exchange of the sorted bills of the first country for the bills and coins of the second country; e) after the step d), determining if the exchangeable money of the second country is more than the stored money of the second country or not; f) as a result of the step e), if the exchangeable money of the second country are less than the stored money of the second country, displaying an amount so the exchangeable money and determining whether there is an input to require the exchange from an user or not; and g) as a result of the step f), if there is input to require the exchange from an user, discharging the money corresponding to the amount of the exchangeable money.

### BRIEF DESCRIPTION OF THE DRAWINGS

Other objects and aspects of the invention will become apparent from the following description of the embodiments with reference to the accompanying drawings, in which:

FIG. 1 is a block diagram illustrating an exchanger for automatically exchanging money in accordance with the present invention;

FIG. 2 is a cross-sectional view illustrating the exchanger in FIG. 1;

FIG. 3 is a front view illustrating the exchanger in FIG. 1;

FIG. 4 is a detailed drawing illustrating a forged bill detection unit in FIG. 2;

FIG. 5 is a detailed drawing illustrating a bill receipt/discharge unit in FIG. 1;

FIGS. 6a to 6c are flow charts showing a calculation process of US dollars into Korean Wons according to an exchange rate in accordance with an embodiment of the present invention;

FIGS. 7a and 7b are flow charts showing a discernment process of kinds of US dollars and a discrimination process of forged bills in accordance with the present invention;

FIG. 8 is a flow chart showing a treatment process of forged US dollars in accordance with the present invention;

FIGS. 9a and 9b are flow charts showing an exchange process of US dollars for Korean Wons in accordance with the present invention; and

FIG. 10 is a flow chart showing an acquisition process of exchange rate through a modem communication in accordance with the present invention.

### BEST MODE FOR CARRYING OUT THE INVENTION

Hereinafter, an apparatus and a method for exchanging money according to the present invention will be described in detail referring to the accompanying drawings.

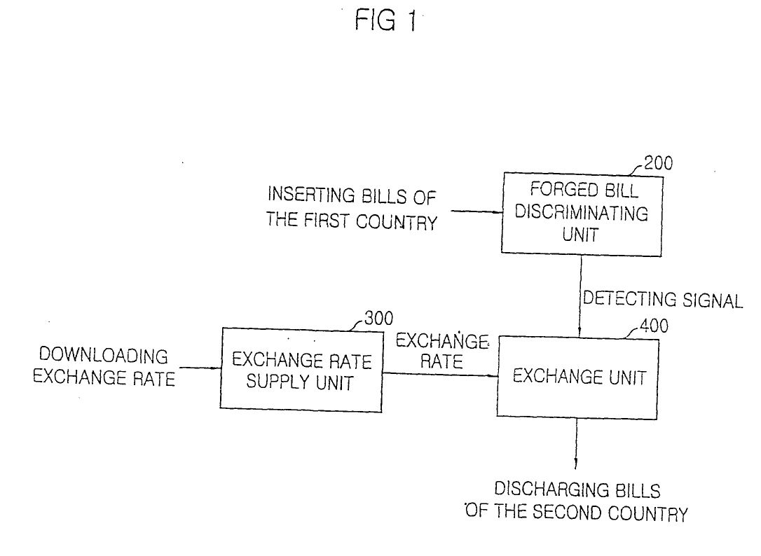

FIG. 1 is a block diagram illustrating an exchange for automatically exchanging money in accordance with the present invention.

Referring to FIG. 1, an exchanger according to the present invention includes a forged bill discriminating unit 200 for detecting if a bill of a first country is forged or not, and sorting the bills when bills of a first country are inserted.

An exchange rate supply unit 300 provides an exchange rate quotation between the first country and a second country, and an exchange unit 400 exchanges the bill of the first country for the bill of the second country according to the exchange rate quotation, in case the bill is not a forged one. The exchange rate supply unit 300 provides an exchange rate quotation of the bill of the first country through a communication network (on-line or off-line), and indicates it by using a displaying means which displays the exchange rate quotation of the bill of the first country.

When the inserted bill of the first country is a forged one, the forged bill discriminating unit 200 discharges the inserted bill or keeps the inserted bill therein to prevent reuse of the forged bill and, if the inserted bill is not a forged one, then stores the inserted bill of the first country.

Also, the exchange unit 400 stores the bills of the second country and, if the inserted bill of the first country is not a forged one, then discharges an exchangeable bill of the second country according to the exchange rate quotation, and exchanges the balance for coins for the second country.

An automatic exchanger of the present invention is capable of exchanging bills of each country, e.g., US dollars, HK dollars, Japanese yens, British founds, French francs and Korean Wons according to an exchange rate quotation.

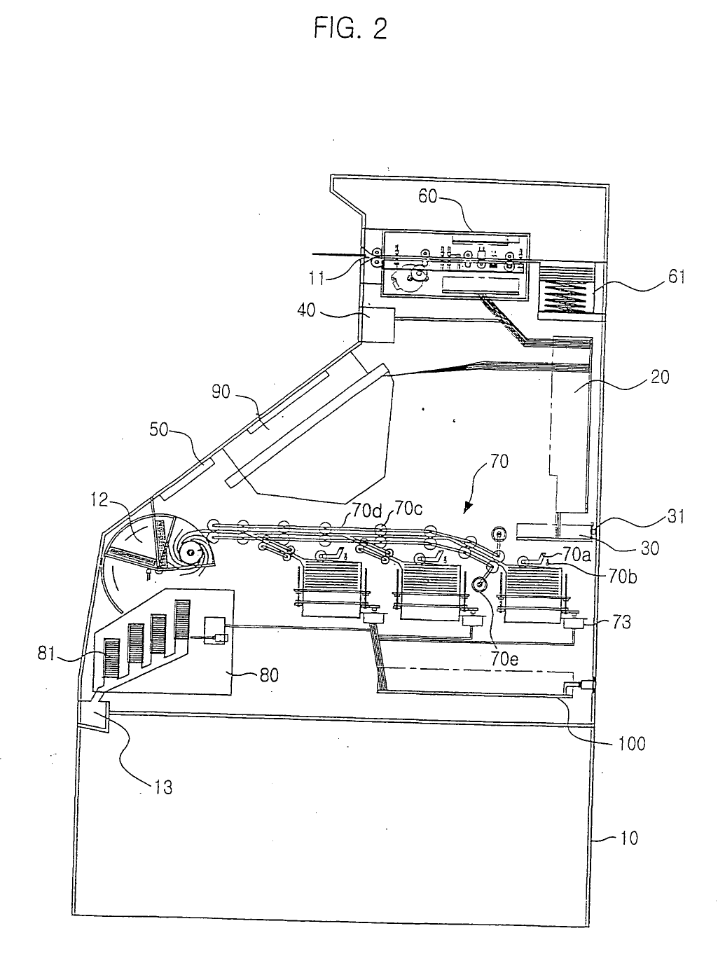

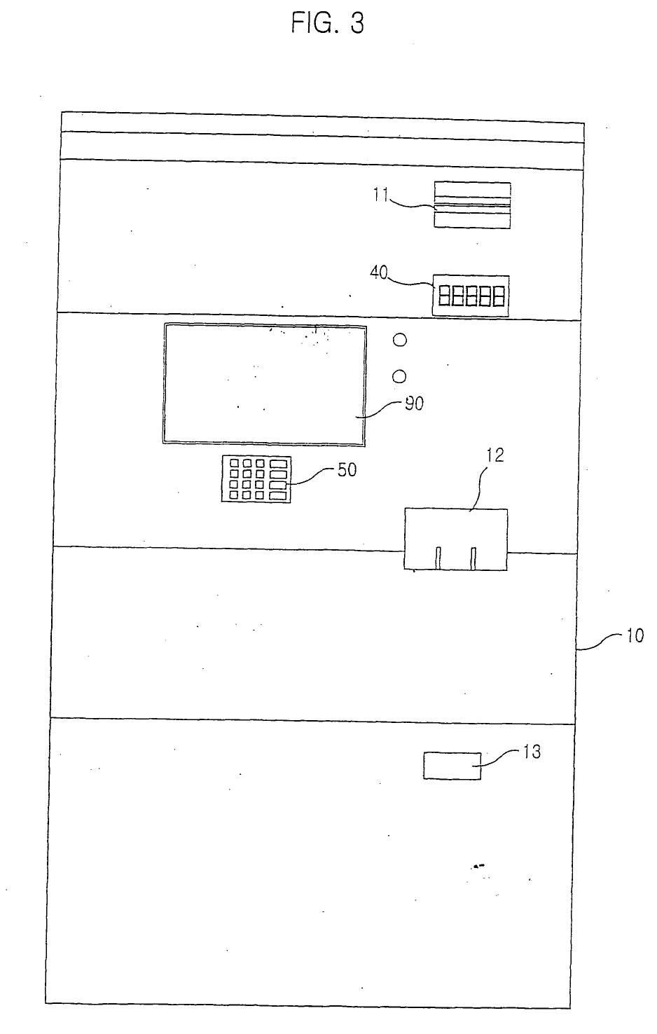

FIG. 2 and FIG. 3 are a cross-sectional view and a front view, respectively, showing the exchanger in FIG. 1.

Referring to FIGS. 2 and 3, the exchanger according to the present invention includes a main body 10 including a liquid crystal display unit 90, a bill insert unit 11, a bill discharge unit 12 and a coin discharge unit 13 in a predetermined portion.

A control unit 20, which is internally equipped to one-side of the main body 10, controls the whole operation. A modem communication unit 30, which is internally connected one-side of the control unit 20, downloads an exchange rate by establishing a communication network through a telephone line 31 ot different private cables.

An exchange rate quotation display unit 40 displays the downloaded exchange rate and then customers can use a key input pad 50 for calculating US dollars into Korean Wons according to the displayed exchange rate quotation. A forged bill detection unit 60 discriminates inserted bills through the bill insert unit 11 and discharges Korean Wons when the inserted bill is a forged one. A bill receipt/discharge unit 70 receives Korean Wons 71, and discharges exchangeable Korean Wons 71 into the bill discharge unit 12 through a motor 73 driving according to the exchange rate quotation when the inserted bill is not a forged one. A coin receipt/discharge unit 80 exchanges the balance of the US dollars for coins 81 of Korean Wons. The main body 10 further includes a power supply unit 100.

On the other hand, the bill receipt/discharge unit 70 has a plurality of containers for storing the bills of the second country by kinds of bills and each of the bills is discharged through one transferring line. Typically, the bills of the second country are discharged in the face values of the bills, i.e., the highest face values of the bills of the second country are first discharged and the lowest face values are lastly discharged. Accordingly, different bills can be transferred to the customers through only one transferring line and the customers can count the discharged bills with easy.

The liquid crystal display unit 90 displays operating massages of the exchanger, such as paper jam and money shortage, etc., and the coin receipt/discharge unit 80, which has been used in other banding machines, is well-known to those having the ordinary skills to which the subject matter pertains. Accordingly, the detailed structure thereof will be omitted.

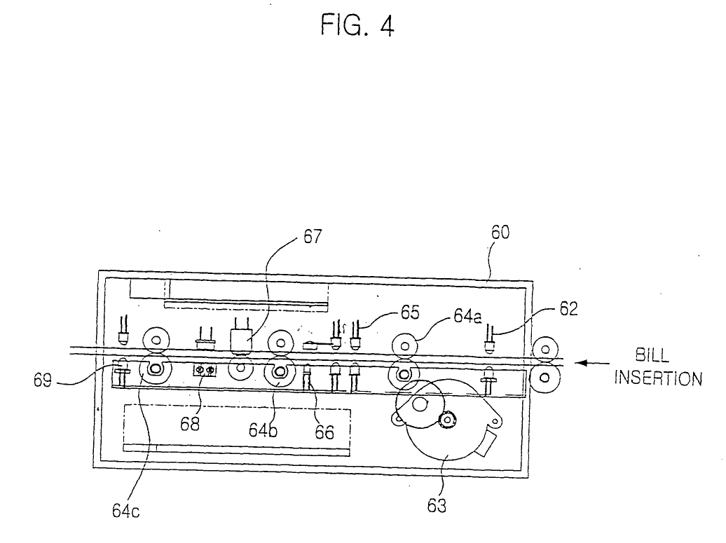

FIG. 4 is a cross-sectional view illustrating the forged bill detection unit 60 in FIG. 2. Referring to FIG. 4, the forged bill detection unit 60 includes a bill detecting sensor 62, which is equipped to the bill insert unit 11, senses the deposition of US dollars and receives the bills. A stepping motor 63 rotates regularly and reversely in response to a detecting signal of the bill supply sensor 62. A first transfer roller 64a, which is equipped to a predetermined portion of the bill supply sensor 62 by crossing in a longitudinal direction; enters the US dollars through rotating power of the stepping motor 63.

An information retrieval (IR) sensor 65, which is equipped to one-side of the first transfer roller 64a, discriminates kinds of the US dollars by sensing differences between reference pattern data and input pattern data based on an amount or a traversed infrared rays which penetrate into the moving US dollars, and discriminates damages so the bill with real data.

A color sensor 66, which is equipped to one-side of the IR-sensor 65, discriminates forgeries of the US dollars with red/green and blue/green data that obtained from printed US dollars. A second transfer roller 64b moves the US dollar which passes through the color sensor 66, and a magnet sensor 67, which is equipped to one-side of the second transfer roller 64b, discriminates magnet patterns on the US dollars to a longitudinal direction for detecting forgeries of the US dollars, by reading out the number of pulses after converting an analogue signal of a magnet pattern into the digital pulse.

An ultraviolet rays sensor 68 discriminates forgeries of the US dollars by illuminating ultraviolet rays on the moving US dollars, and compares a reference amount of visible light with transmitted amount of the visible light produced by s fluorescent material contained in the US dollar.

A third transfer roller 64c moves the US dollar, which passes through the ultraviolet sensor 68, to a discharging part, and a discharging sensor 69 detects the US dollars that are moved through the third transfer roller 64c. Also, the forged bill detection unit 60 further includes a first transfer belt (not shown) for transferring rotation power by connecting each portion of the first transfer roller 64a to the second transfer roller 64b, and a second transfer belt (not shown) for delivering rotation power by connecting another portion of the second transfer roller 64b to the third transfer roller 64c.

The forged bill discriminating unit 60 controls forward and reverse rotation by applying a control signal to the stepping motor 63 after receiving discriminating signals from the bill supply sensor 62 and the discharging sensor 69.

Also, the forged bill discriminating unit 60 amplifies the discriminated signals from the color sensor 66 and the ultraviolet sensor 68 and a signal discriminated from a head of the magnet sensor 67 to determine if the inserted US dollar is forged one or not. If the US dollar is not a forged one, the forged bill discriminating unit 60 stores it into a US dollar storing unit 61.

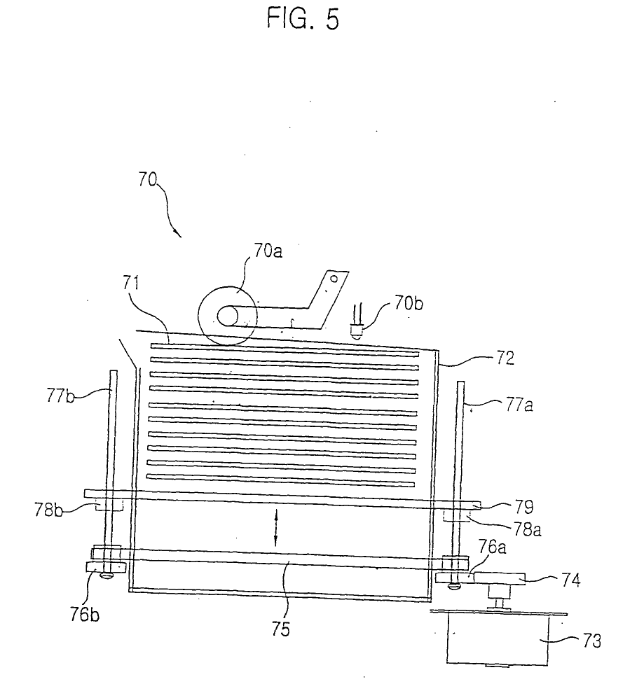

FIG. 5 is a detailed drawing illustrating a bill receipt/discharge unit, in FIG. 1;

Referring to FIG. 5, a bill receipt/discharge unit 70 includes a container 72 for storing bills of Korean Wons 71, and a driving motor 73, which is equipped to outside of the container 72, is driven by power supply. A gear 74, which is equipped to outside of the container 72, is rotated by the driving motor 73 and first and second pulley gears 76a and 76b are connected each other through a driving belt 75, wherein the first pulley gear 76a is connected to the gear 74.

A plate 79 is engaged with first and second axes 77a and 77b having pick up the screws connected to axes of the first and second pulley gears 76a and 76b by using first and second nuts 78a and 78b, and moves up and down by rotation of the first and second axes 77a and 77b.

A bill pickup roller 70a picks up the bill of the Korean Wons 71 when the plate 79 is moved upwards, and a bill existence discriminating sensor 70b discriminates the bill of the Korean Wons stored on the container 72.

Referring again to FIG. 2, the bill receipt/discharge unit 70 further includes a transfer roller 70c and a transfer belt 70d for transferring the picked-up bill to the bill discharge unit 12, wherein the transfer roller 70c and the transfer belt 70d are equipped to outside of the container 72, and the transfer roller 70c is driven by a roller driving motor 70e.

The bill receipt/discharge unit 70 drives the roller driving motor 70e according to a signal notifying the storage of bills from the bill existence discriminating sensor 70b. The bill pickup roller 70a is operated to pick up the Korean Wons 71 and transfers the picked-up bill Then the bill receipt/discharge unit 70 stores exchangeable bills of Korean Wons for the US dollars and discharge the Korean Wons into the bill discharge unit 12.

Specifically, when the roller driving motor 70e is driven, the gear 74 is driven too, and when the first pulley gear 70a connected to the gear 74 is rotated, then the second pulley gear 76b is rotated too with the driving belt 75, thereby moving the plate 79 mounted on the first and second nuts 78a and 78b to the first and second axes 77a and 77b forming the pick of screw, up and down.

When the plate 79 is moved upwards, the bill is picked up one by one by the first bill pickup roller 70a and there is no bill, the bill existence discriminating sensor 70b notify it to the control unit 20.

The exchanger of the present invention automatically sets up an exchange rate in conformity to exchange rate notification time (twice or more in a day) through a modem communication and, in case that the modem communication is impossible, the exchange rate quotation can be inputted manually. In case of a system error, the corresponding error code and contents thereof are transmitted through the modem communication to an exchanging service provider managing the exchanger of the present invention. The number of times to update the exchange rate can be established by the exchanging service provider.

The exchanger also has a calculation function for previously inquiring an amount of the exchangeable money by keypad inputs. When bills or papers other than the US dollars are inserted, the exchanger discharges them automatically and, when a forged bill is inserted, the exchanger selectively sets up the functions of discharging or keeping them.

Subsequently, when a forged bill is inserted, the exchanger makes an alarm or notification such a forgery with voice to a predetermined phone number. In this case, an exchangeable amount of US dollars based on the stored Korean Wons can be displayed on the exchanger.

As above described, the present invention determines forgeries of US dollars reliably and sorts the US dollars according to its kinds. If the US dollar is not a forged one, an amount of exchangeable Korean Wons is displayed based on the exchange rate quotation received through communication network and the amount of displayed money is exchanged from the US dollars to Korean Wons.

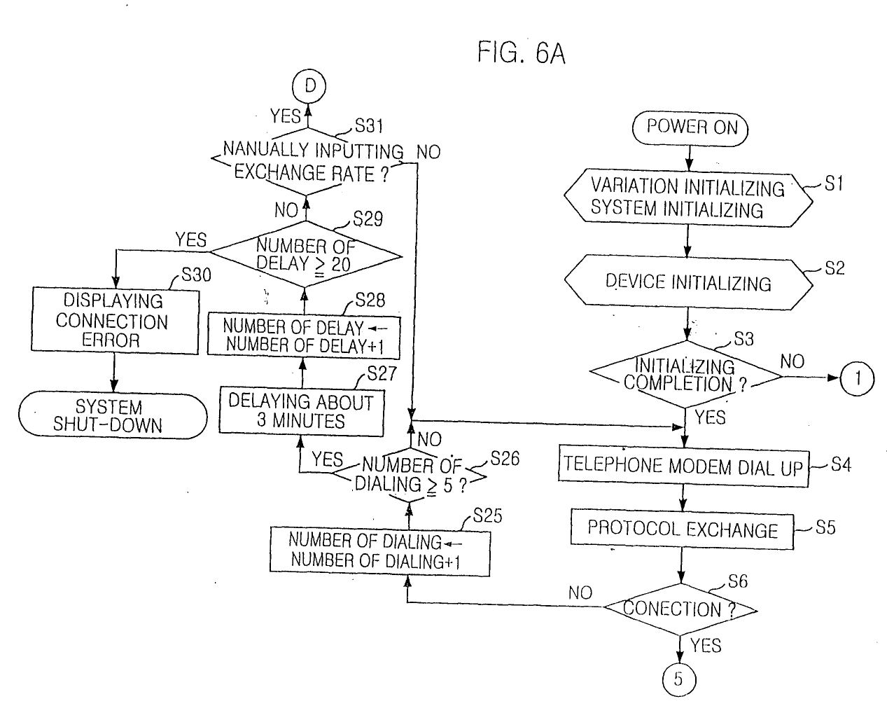

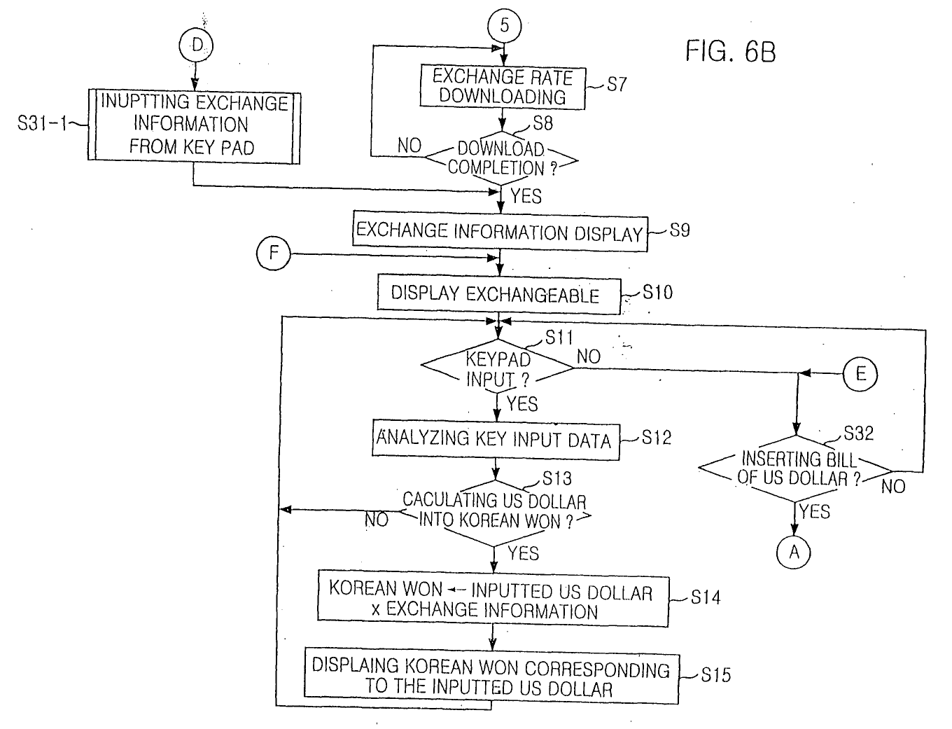

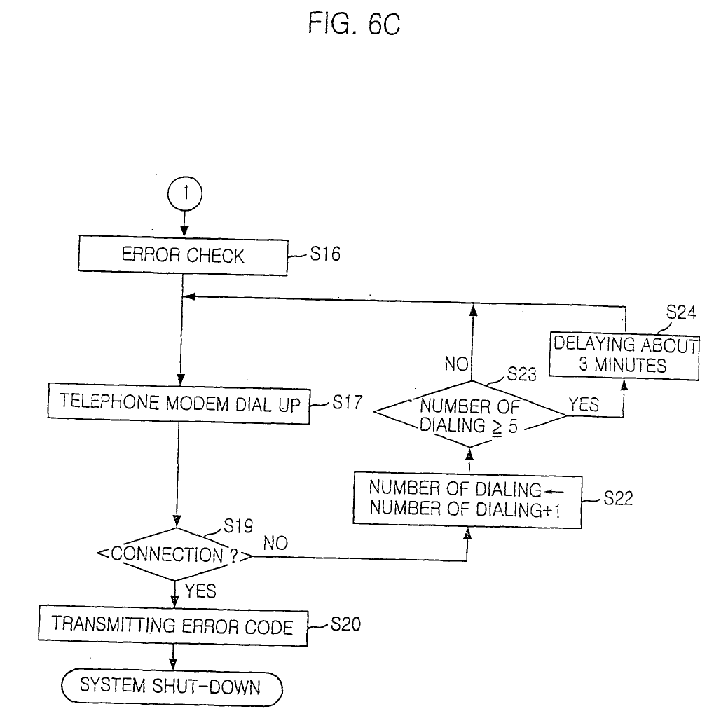

FIGS. 6a to 6c are flow charts for calculating US dollars into Korean Wons based on an exchange rate.

When power is supplied to the exchanger, all systems of the exchanger including the forged bill discriminating unit 60, the exchange rate quotation display unit 40, the bill receipt/discharge unit 70 and the control unit 20 are initialized, and every variable and a driving apparatus are initialized at steps S1 and S2.

At step S3, the automatic exchanger according to the present invention determines if an initialization of the systems, variables and driving apparatuses are completed and, if not, an error is checked at step S16 (in FIG. 3B) and the exchanger dials up an exchange service provider through a modem at step S16 and exchanges protocols with the exchange service provider at step S18.

At step S19, the exchanger determines if the system is connected to the communication network, and if connected, it transmits an error code and demands a service at steps S20 and S21, then shuts down the system.

At step S19, if the protocol is exchanged while the initialization is not completed and the system is not connected to the communication network, the exchanger increases the number of dialing up to five. In case the number of dialing is more than five, a dialing is retried again after delaying for about three minutes, and in case the number of dialing is below five, the dialing is retried again to be connected to the communication network without the delay time at steps S22 and S24.

Subsequently, when the initialization of the exchanger is completed, it exchanges the protocols by dialing-up the modem at steps S4 and S5, and determines if the system is connected to the communication network at step S6, and if connected, a download operation of the exchange rate is carried out at step S7 as shown in FIG. 6B, otherwise, increases the number of dialing one by one.

At steps S25 to S30, if the dialing numbers are over five, a dialing is retried again after delaying for about three minutes, and if the delaying numbers are over twenty, the exchanger displays a malfunction of communication network and shuts down the system.

At step S31, when the delaying numbers are below twenty, a manager can determine if the exchange rate is manually inputs by using a keypad at step S31, and if not, it continuously tries the modem dialing to be connected to the communication network.

Referring to FIG. 6b, at step S8, after determining completion of the exchange rate, if the download is completed, the exchanger displays the exchange rate on an exchange rate quotation displayer and displays exchangeability in such a downloaded exchange rate.

Hereinafter, an operation for calculating US dollars into Korean Wons according to the downloaded exchange rate information will is described.

First, at step S11, the exchanger determines if there exists a keypad input, and if exists, it analyzes the keypad input data at the step S12 and asks if a customer want to calculate the US dollars into the Korean Wons at step S13, and if asked, it displays the calculated Korean Won by using the inputted US dollars and the exchange rate information, and displays bills of the inputted US dollars at steps S14 and S15.

At step S32, if there is no keypad input, the exchanger asks whether the customer directly inputs the US dollars without displaying an amount of exchangeable Korean won for the US dollars, and if there is no input of the US dollars, it asks the keypad input again.

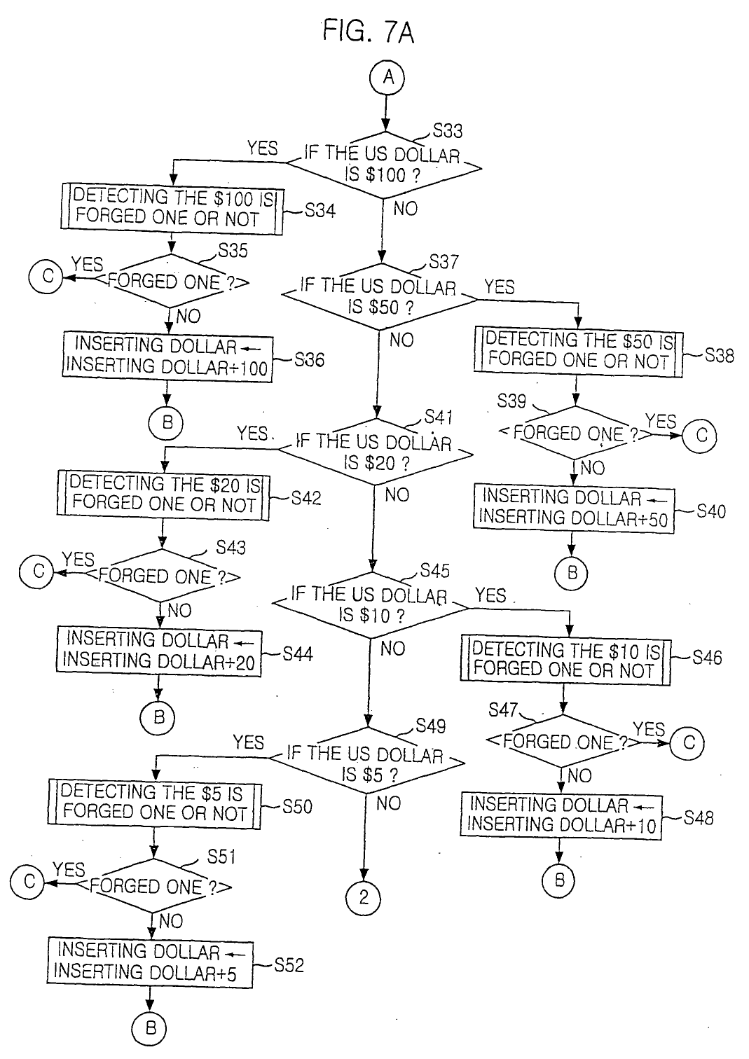

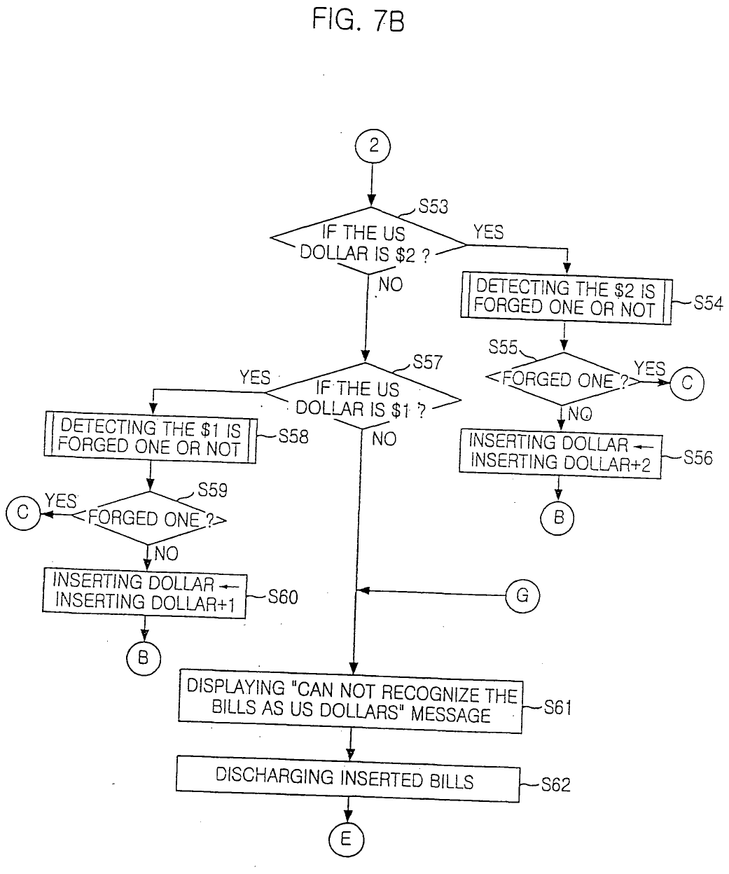

FIGS. 7a and 7b are flow charts showing a determining process of US dollars and discriminating process of forged bills in accordance with the present invention.

The exchanger sorts the US dollars when bills of US dollars are inserted, and if the bills are $100, it discriminates whether the $100 bill is forged one, and if not, a customer may insert the $100 bill successively, at steps S33 to S36.

If the bills are $50, the exchanger discriminates whether the $50 bills are forged one or not, and if not, a customer may insert the $50 bills successively, at steps S37 to $40, and if the bills are $20, it discriminates whether the $20 bills are forged one or not, and if not, a customer may insert the $20 bills successively, at steps S41 to S44. Also, if the bills are $10, the exchanger discriminates whether the $10 bills are forged one or not, and if not, the customer may insert the $10 bills successively, at steps S45 to S48, and if the bills are $5, it discriminates whether the $5 bills are forged one or not, and if not, a customer may insert the $5 bills successively, at steps S49 to S52.

Likewise, at steps S53 to S56, if the bills are $2, the exchanger discriminates whether the $2 bills are forged one or not, and if not, a customer may insert the $2 bills successively.

Finally, if the bills are $1, the exchanger discriminates whether the $1 bills are forged or not, and if not, the customer may insert the $1 bills successively, at steps S57 to S60.

Meanwhile, at steps S61 and S62, if the inserted bills are not $1, then the exchanger displays “Can not recognize the bills as US dollars” message to the customer, and it discharges the inserted bills.

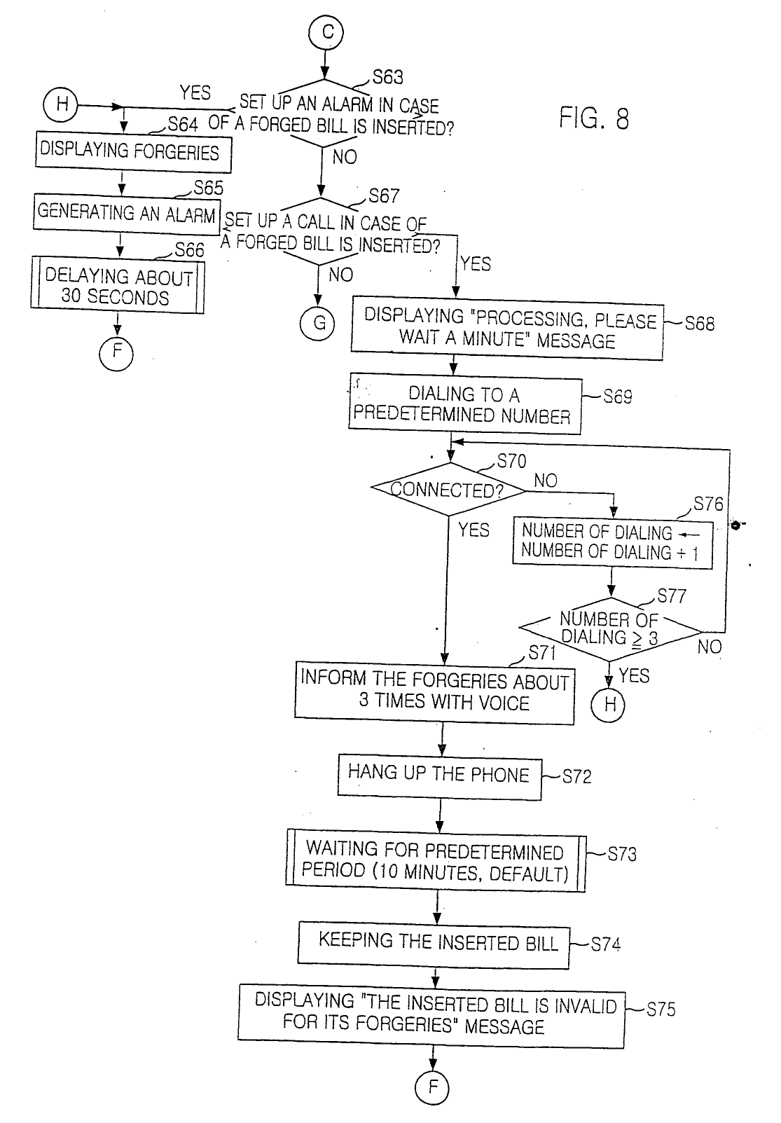

FIG. 8 is a flow chart showing a treating process or forged US dollars in accordance with the present invention.

First, according to the US dollars ($100, $50, $20, $10, $5, $2 and $1), the exchanger determines whether the inserted US dollar bills in FIG. 6 are forged one or not, and when the bills are forged one, at step S63, it determines if an alarm is set up, and if set up, it displays forgeries and raising an alarm and delays about 30 seconds at steps S64 to S66, then proceeds to step S10 which the exchanger displays exchangeability.

In case the alarm is not set up, then when a forged bill is inserted, the exchanger determines if an alarm is set up at step S67, and if the alarm is set up, then at step S68, it displays “Processing, please wait a minute” message to the customer, and the exchanger dials predetermined number and determines whether the system is connected to the communication network or not, at steps S69 and S70, and if connected, it informs the forgeries about three times with voice and hanging up the phone call at steps S71 and S72.

Subsequently, the exchanger waits for a predetermined period (10 minutes, default) and keeps the inserted bill at steps S73 and S74, and it displays “The inserted bill is invalid for its forgeries” message at step S75, then it proceeds to step S10 which the exchanger displays exchangeability.

At this time, if the phone call is not connected, the exchanger increases the number of dialing one by one, and if the number of dialing is more than three at steps S76 and S77, it directly displays that the inserted bill is a forged one and raises an alarm at steps S64 and S65, and delays about 30 seconds at step S66, then it proceeds to step S10 which the exchanger displays exchangeability.

If the above-mentioned call is not setting up, the exchanger displays “Can not recognize the bills as US dollars” message to the customer as in FIG. 2 and then it discharges the inserted bills at steps S61 and S62.

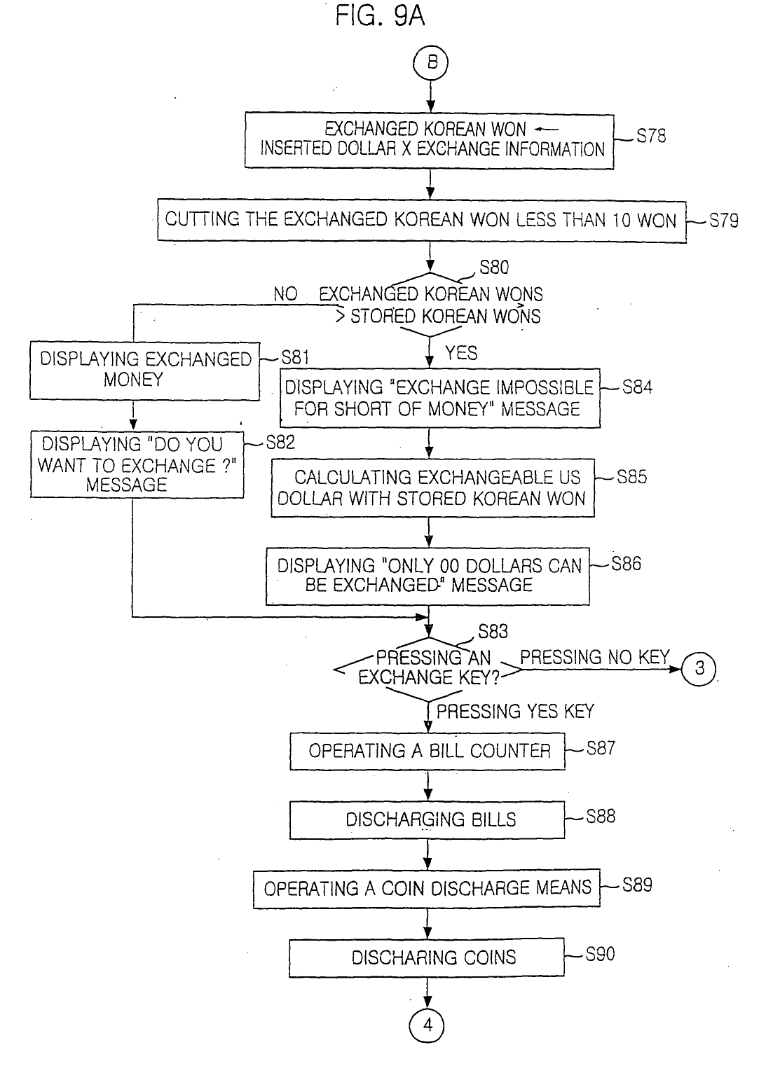

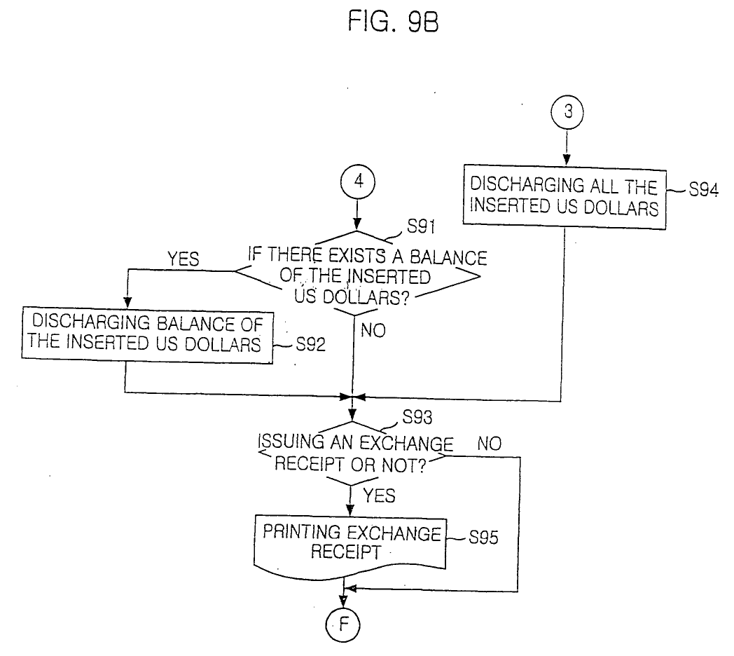

FIGS. 9a and 9b are flow charts showing an exchange process of US dollars for Korean Wons in accordance with the present invention.

After the exchanger discriminates forgeries according to the US dollars, if the inserted bills are not forged ones and continuously inserted into the automatic exchanger, it displays an amount of exchangeable Korean Wons by multiplying exchange rate information by the inserted dollars at step S78.

At step S79, when the exchangeable Korean Wons are less than 10 won, then the exchanger cuts the money. Successively, the exchanger determines if the stored Korean Wons are more than the amount of exchangeable Korean Wons at step S80, and if many, it displays an amount of the exchangeable money with “Do you want to exchange?” message at steps S81 and S82.

Meanwhile, if the stored Korean Wons are less than the Korean won to be exchanged, the exchanger displays “Exchange impossible for short of money” message to the customer at step S84, and it calculates an exchangeable money with the amount of stored Korean Wons, then it displays “Only 00 dollar can be exchanged” message to the customer at step S86.

Subsequently, in response to the “Do you want to exchange?” and the “Only 00 dollar can be exchanged” messages at steps S84 and S86, respectively, at step S83, the customer determines whether presses an exchange key or not, and in case the customer presses the exchange key to ask for the exchange, a bill counter is operated to discharge the Korean Wons stored at the bill receipt/discharge unit 700 at steps S87 and S88, and a coin discharge means is operated to discharge changes at steps S89 and S90.

At step S91, the exchanger determines if a balance of the inserted US dollars exists, and if exists, it discharges the balance at step S92 and asks to the customer whether an issuance of the exchange receipt is required or not at step S93, otherwise, directly asks to the customer whether an issuance of the exchange receipt is required or not at step S93. Meanwhile, at step S83, as a result or asking whether the customer presses the exchange key or not, and if not, the exchanger discharges all the inserted US dollars at step S94, then it asks to the customer whether an issuance of the exchange receipt is required or not at step S93. As a result, if the customer asks for issuing the exchange receipt, the exchanger prints the exchange receipt at step S95.

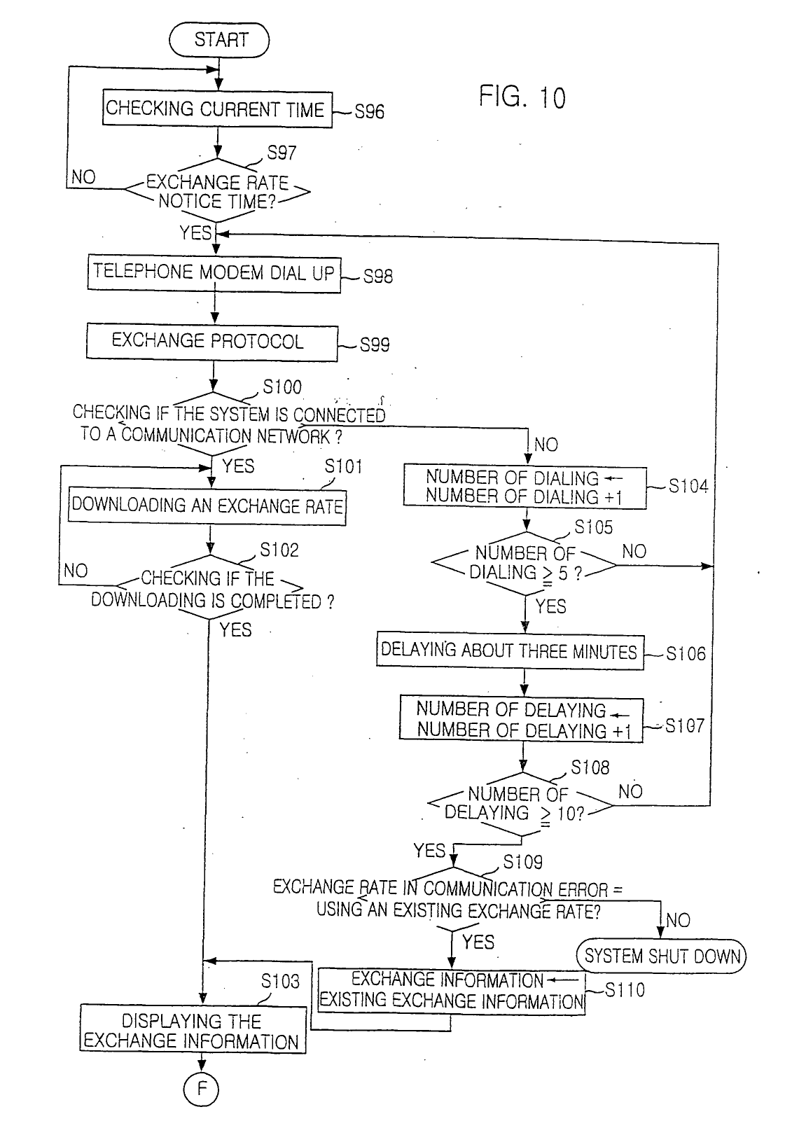

FIG. 10 is a flow chart showing an acquisition process of exchange rate through a modem communication in accordance with the present invention.

When the system is initialized by a power supply, at step S96, the exchanger checks up current time and at step S97, it determines if current time is the time to notify an exchange rate, and if right, it dials a modem to exchange a protocol at steps S98 and S99.

At step S100, the exchanger determines whether the system is connected to a communication network or not, and if connected, it downloads an exchange rate at step S101, and when the download is completed, the exchanger displays the exchange rate at steps S102 and S103.

If the system is not connected to the communication network, the exchanger increases the number of dialing one by one at step S104. At step. S105, it determines if the number of dialing is over five, and if right, it delays about three minutes and increases the number of delaying one by one at steps S106 and S107. At step S108, the exchanger determines if the number of delaying is over ten, and if right, it determines whether using an existing exchange rate as a standard rate in case of networking error.

At steps S110 and S103, if the existing exchange rate is used, the exchanger changes current exchange rate into the existing exchange rate and it displays the exchange rate to the customer. When the communication network has an error and the existing exchange rate may not be used as a standard exchange rate, the exchanger shuts down the system.

As above-mentioned, the present invention is not confined to exchange US dollars for Korean Wons. With the present invention, Korean Wons may be exchanged for US dollars and any bill can be exchanged for a bill of any other country.

The present invention can automatically exchange an exchange rate according to an exchange rate notifying time with real time through a modem communication, transfer an error code and contents thereof when the system has an error, and can previously calculate an amount of exchanging money by using a keypad.

Also, before exchanging an inserted bill of a first country, the bill of the first country may be sorted and forgeries may be discriminated by using a forged bill discriminating means to discharge or keep the forged bill. Moreover, when forced bills are discriminated, an alarm or a telephone line is used to notify the forgeries.

A bill existence discriminating sensor is used for checking an amount of bills of the second country stored in the automatic exchanger, and the automatic exchanger of the present invention can display an amount of exchangeable money of the first country according to the stored money of the second country. An inverse calculating is possible to efficiently exchange the bills of the first country for the bills of the second country.

Although the preferred embodiments or the invention have seen disclosed for illustrative purposes, those skilled in the art will appreciate that various modifications, additions and substitutions are possible, without departing from the scope and spirit of the invention as disclosed in the accompanying claims.

1. An apparatus for automatically exchanging money, comprising:
a forged bill discriminating means for sorting kinds of bills of a first country and discriminating forgeries thereof;
an exchange rate providing means for providing an exchange rate quotation; and
an exchange means for automatically exchanging the bills of the first country for bills of a second country based on the exchange rate from the exchange rate providing means in case where the bills of the first country are not forged ones.

2. The apparatus of claim 1, wherein the exchange rate displaying means provides an exchange rate quotation by using on-line or off-line.

3. The apparatus of claim 1, wherein the exchange means exchanges a balance of the exchanged bills of the first country for coins of the second country.

4. The apparatus of claim 1, wherein the exchange means comprises:
a plurality of containers for storing the bills of a second country by kinds of bills; and
discharging means connected to each of containers for discharging the bills of the second country through one discharging line.

5. An exchanging apparatus or automatically exchanging a bill of a first country for a bill of a second country, comprising:
an exchange rate providing means for providing an exchange rate between the bills of the first and second countries;
an exchange rate displaying means for notifying the exchange rate of the bill of the first country;
a key input means for calculating an amount of exchangeable money of the first country for the second country according to the notified exchange rate;
a forged bill discriminating means for discriminating the bill of the first country and sorting kinds of the bills of the first country;
a bill receipt/discharge means for receiving the bills of the second country and discharging the exchangeable bill of the second country according to the exchange rate of the bill of the first country when the inputted the bills of the first country are not forged ones; and
a coin receipt/discharge means for exchanging a balance of the exchanged bill of the first country for coins of the second country and discharging the coins.

6. The exchanging apparatus of the claim 5, wherein the exchange rate providing means provides an exchange rate quotation with on-line or off-line.

7. The exchanging apparatus of the claim 5, wherein the forged bill discriminating means comprises:
a bill feeding means for sensing setting or the bills of the first country and providing the bills;
a moving means for moving the bills of the first country, wherein the moving means operates in response to a sensing signal from the bill feeding means;
a bill sorting means for sorting kinds of the bill of the first country based on length and thickness of the bills of the first country and for discriminating kinds of the bills thereof;
a detecting means for detecting forgeries of the bills which are sorted by the bill sorting means;
a receipt means for storing the bills of the first country when the bills are not forged ones; and
a discharge means for discharging the bills of the first country when the bills are forged ones.

8. The exchanging apparatus of the claim 5, wherein the bill receipt/discharge means comprising:
a container for storing the bills of the second country;
first and second pulley gears respectively engaged with first and second axes and connected each other through a driving belt, wherein the first pulley gear receives rotation power from a driving motor and te first and second pulley gears are equipped to outside of the container;
nuts moving upwards and downwards by rotation of the first and the second axes which is caused by rotation of the first and second pulley gear;
a movable plate mounted on the nuts for moving upwards and downwards by rotation of the nuts;
a bill pickup roller for picking up the bills of the second country when the plate is moved upwards; and
a bill existence detecting sensor for detecting the bills of the second country stored in the container is stored or not; and
a transfer roller and a transfer belt for discharging picked up bills of the second country.

9. The exchanging apparatus of claim 5, wherein the bill receipt/discharge means comprises:
a plurality of containers for receiving and storing the bills of a second country by kinds of bills; and
discharging means connected to each of containers for discharging the bills of the second country through one discharging line

10. An exchanging apparatus for automatically exchanging bills of a first country for bills of a second country comprising,
a main body including a liquid crystal display unit, a bill insert unit, a bill discharge unit and coin discharge unit;
a control unit for controlling the whole operation, wherein the control unit is internally equipped to one-side of the main body;
an exchange rate providing means for providing an exchange rate between bills of the first and second countries, wherein the exchange rate providing means is connected to one-side of the control unit;
an exchange rate displaying means for displaying the received exchange rate;
a key input means for optionally providing calculation of an amount of exchangeable bills of the second country according to the provided exchange rate;
a forged bill discriminating means for discriminating bills inserted through the bill insert unit and discharging a forged bill;
a bill receipt/discharge means for receiving the bills of the second country and discharging exchangeable bills of the second country into the bill discharge unit by a motor driving according to the provided exchange rate; and
a coin receipt/discharge means for exchanging a balance of the bill of the first country for coins of the second country and discharging the coins.

11. The exchanging apparatus of the claim 10, wherein the forged bill discriminating means comprising:
a feeding sensor for sensing a setting of the bills of the first country and supplying the bills, wherein the feeding sensor is equipped in the bill insert unit;
a transfer roller for moving the bills of the first country in response to a sensing signal from the sensor;
a bill sorting means for sorting kinds of the bills of the first country based on length and thickness of the bills of the first country and for discriminating kinds of the bills thereof, wherein the bill discriminating means is located in a upper part of the main body;
a color discriminating means for discriminating color pictures on the bills of the first country, wherein the color discriminating means is equipped to one-side of the bill sorting means;
a magnet pattern discriminating means for discriminating a magnet line on the bills of the first country, wherein the magnet pattern discriminating means is equipped to one-side of the color discriminating means;
a ultraviolet rays sensor for illuminating ultraviolet rays onto the bills of the first country and discriminating an amount of visible light from a fluorescent material in the bills of the first country, wherein the ultra violet rays sensor is equipped to one-side of the magnet pattern discriminating means;
a discharging means for discharging the bills of the first country by sensing a discharging condition thereof, wherein the discharging means is equipped to one-side of the ultraviolet rays sensor;
a control mean receiving a inserted bill sensing signal from the feeding sensor and the discharging means and transmitting a driving control signal to a moving, discriminating the kinds of the bills of the first country according to a sensing signal from the bill sorting means, and determining forgeries of the bills of the first country in response to the sensing signals from the color discriminating means, the magnet pattern discriminating means and the ultraviolet rays sensor; and
a dollar receipt means for storing a discharged dollar through the discharging means.

12. The exchanging apparatus of the claim 11, wherein the bill receipt/discharge means comprising:
a container for storing the bills of the second country;
first and second pulley gears respectively engaged with first and second axes and connected each other through a driving belt, wherein the first pulley gear receives rotation power from a driving motor and the first and second pulley gears are equipped to outside of the container;
nuts moving upwards and downwards by rotation of the first and the second axes which is caused by rotation of the first and second pulley gear;
a movable plate mounted on the nuts for moving upwards and downwards by rotation of the nuts;
a bill pickup roller for picking up the bills of the second country when the plate is moved upwards; and
a bill existence detecting sensor for detecting the bills of the second country stored in the container is stored or not; and
a transfer roller and a transfer belt for discharging picked up bills of the second country.

13. The exchanging apparatus of the claim 11, wherein the exchange rate providing means provides an exchange rate quotation by using on-line or off-line.

14. The exchanging apparatus of claim 11, wherein the bill receipt/discharge means comprises:
a plurality of containers for receiving and storing the bills of a second country by kinds of bills; and
discharging means connected to each of containers for discharging the bills of the second country through one discharging line

15. An automatically exchanging method, wherein the method exchanges a bill of a first country for money of a second country using an automatic exchange system, comprising the steps of:
a) providing and displaying an exchange rate;
b) sorting kinds of the bills of the first country and discriminating forgeries of the bills; and
c) if the bill is not a forged one, discharging the money of the second country according to the exchange rate.

16. The method of the claim 15, wherein the step a) includes the steps of:
a1) determining whether an initialization is completed or not;
a2) when the initialization is completed, discriminating current time and determining whether it is time to notify the exchange rate;
a3) if it is time to notify the exchange rate, trying a communication network connection;
a4) determining whether the automatic exchanging system is connected to the communication network or not;
a5) if the system is connected to the communication network, downloading the exchange rate of the bills of the first country; and
a6) determining if the download is completed, and if completed, displaying the exchange rate.

17. The method of the claim 15, wherein the method includes the steps of:
a7) after the step a), displaying possibility of the exchange based on the downloaded exchange rate;
a8) determining if the bill of the first country is inserted or not;
a9) if the bill of the first country is inserted, analyzing data of the inserted bill of the first country and asking whether an exchange calculation is required between the first and second countries; and
a10) if a user asks the calculation, calculating the bills of the first country into the money of the second country based on the exchange rate and displaying a calculated amount of the money of the second country.

18. The method of the claim 17, wherein the step b) includes the steps of:
b1) if the bill of the first country is a forged one, determining whether an alarm is set up or not;
b2) if the alarm is set up, displaying the inserted bill of the first country is a forged one and generating an alarm;
b3) generating the alarm during a predetermined period and carrying out the step a10);
b4) if an alarm is not set up, determining whether a call is set up or not;
b5) if the call is set up, displaying a predetermined specific message and making a phone call to a predetermined number;
b6) after making the phone call, determining whether the system is connected to the communication network or not;
b7) if the system is connected to the communication network, notifying the forged bill;
b8) after hanging up the phone call, waiting for a predetermined period and keeping the inserted forged bill;
b9) after keeping the forged bill, displaying a message notifying that the inserted bill is invalid; and
b10) processing the step a10).

19. The method of the claim 16, wherein the step c) includes the steps of:
c1) exchanging the bills of the first country for the money of the second country according to an exchange rate;
c2) determining if the exchangeable money of the second country are more than the stored;
c3) if the exchangeable money of the second country are less than the stored money, displaying an amount of the exchangeable money and determining if there is an input of an exchange key from an user or not; and
c4) if there is the input of the exchange key from the user, discharging the money coins of the second country corresponding to the displayed amount of the exchangeable money.

20. An automatically exchanging method, wherein the method exchanges bills of the first country for money of the second country using an automatic exchange system, comprising the steps of:
a) determining if an initialization of the automatic exchange system is completed, and if completed, downloading an exchange rate of the bills of the first country through a modem communication;
b) calculating the bills of the first country into the money of the second country according to the downloaded exchange rate and displaying the calculated amount;
c) after the step a), receiving the bills of the first country, sorting kinds of the inserted bills of the first country and determining if the bill of the first country is a forged one or not;
d) at the step c), if the bills of the first country are not forged ones, preparing the exchange of the sorted bills of the first country for the bills and coins of the second country;
e) after the step d), determining if the exchangeable money of the second country is more than the stored money of the second country or not;
f) as a result of the step e), if the exchangeable money of the second country are less than the stored money of the second country, displaying an amount of the exchangeable money and determining whether there is an input to require the exchange from an user or not; and
g) as a result of the step f), is there is input to require the exchange from an user, discharging the money corresponding to the amount of the exchangeable money.

21. The method of the claim 20, wherein the step includes the steps of:
a1) when the initialization is completed, discriminating current time and determining whether it is time to notify the exchange rate;
a2) if it is time to notify the exchange rate, trying a communication network connection;
a3) determining whether the system is connected to the communication network or not;
a4) if the system is connected to the communication network, downloading an exchange rate of the bills of the first country; and
a5) determining if the downloading is completed, and if completed, displaying the exchange rate.

22. The method of the claim 20, wherein the step b) includes the steps of:
b1) displaying possibility of the exchange according to the downloaded exchange rate;
b2) determining if bill of the first country is inserted or not;
b3) when the bill of the first country is inserted, analyzing data of the inserted bill of the first country and asking whether a calculation between the bills of the first country into the money of the second country; and
b4) after the step b3), when a user asks calculation, calculating the bills of the first country into the money of the second country based on the exchange rate and displaying the exchangeable money of the second country.

23. The method of the claim 22, wherein the step d) includes the steps of:
d1) if the bill of the first country is a forged one, determining whether an alarm is set up or not;
d2) when an alarm as set up, displaying a forgery of the inserted bills of the first country and generating an alarm; and
d3) generating the alarm during a predetermined period and carrying out the step b4).

24. The method of the claim 22, whereon the step d) includes the steps of:
d4) when an alarm is not set up, determining whether a call is set up or not, wherein the call is used when a forged bill is inserted;
d5) if the call is set up, displaying a notice to process the exchange and making a phone call to a predetermined number;
d6) after making the phone call, determining whether the system is connected to the communication network or not;
d7) if the system is connected to the communication network, notifying the forgeries in voice and hanging up the phone call;
d8) after hanging up the phone call, waiting for a predetermined period and keeping the inserted forged bill;
d9) after keeping the forged bills, notifying an invalidity for the forged bill; and
d10) after displaying the message, processing the step b3).

25. The method of the claim 20, wherein the step e) includes the steps of:
e1) if the stored bills of the second country are less than the exchangeable bills of the second country, notifying an impossibility for short of money;
e2) after displaying the message, reversely calculating exchangeable bills of the first country with the stored bills of the second country and displaying the exchangeable bills of the first country; and
e3) after displaying the exchangeable bills of the first country, processing the step f).

26. The method or the claim 20, as a result of the step f), if a user doesn't require to exchange the bills of the first country for the money of the second country, discharging all the inserted bills of the first country.

27. The method of the claim 22, wherein the method, includes the steps of
g1) determining if a balance of the inserted bills of the first country exists;
g2) if the balance exists, discharging the balance of the inserted bills of the first country;
g3) if there is no balance, asking whether an is issuance of an exchange receipt is required or not;
g4) if a user asks for the exchange receipt, printing the exchange receipt; and
g5) after printing the exchange receipt, processing the step b3).

28. The method of the claim 20, wherein the step a) includes the steps of:
a7) if the initialization is not completed, discriminating an error code and exchanging protocols by using a modem;
a8) after the protocol exchange, determining if a communication network is connected;
a9) if the system is connected to the communication network, transmitting the error code, asking for a service and shutting down the system;
a10) if the system is not connected to the communication network, increasing number of the dialing though the modem;
a11) if the number of dialing is over five, delaying or a predetermined period and redialing through the modem; and
a12) if the number of dialing is below five, directly redialing through the modem.
